(19) United States
(12) Patent Application Publication
(10) Pub. No.: US 2020/0211390 A1
(43) Pub. Date: Jul. 2, 2020

(54) SYSTEM AND METHOD FOR REQUEST AND TRANSFER OF PARKING AVAILABILITY

(71) Applicant: Parkarr, LLC, New York, NY (US)

(72) Inventor: Robyn Gerber, New York, NY (US)

(73) Assignee: Parkarr, LLC, New York, NY (US)

(21) Appl. No.: 16/728,930

(22) Filed: Dec. 27, 2019

Related U.S. Application Data
(60) Provisional application No. 62/786,319, filed on Dec. 28, 2018.

(51) Int. Cl. G08G 1/14; H04W 4/021; H04W 4/02; G06Q 10/02; G07B 15/02

(52) U.S. Cl. CPC G08G 1/143; H04W 4/021; G07B 15/02; H04W 4/027; G06Q 10/02; H04W 4/023

(57) ABSTRACT

An apparatus and method are presented for request and transfer of parking availability. The apparatus and method may comprise at least one device configured for receiving requests for available parking locations from a first user, receiving notifications of an available parking location from a second user, sending notifications to a first user and/or a second user, sensing geo-location of a user, and sensing a speed and/or acceleration of a user. The apparatus and method may be configured to provide time estimations for arrival of a second user at an available parking location and may be configured to facilitate transfer of available parking to a user who reserved the parking location. The apparatus and method may be further configured to provide notifications of parking availability based on street signs in free or metered parking locations.

### RELATED APPLICATIONS

This application claims priority under 35 U.S.C. § 119(e) of U.S. Provisional Application Ser. No. 62/786,319, titled “SYSTEM AND METHOD FOR REQUEST AND TRANSFER OF PARKING AVAILABILITY,” filed on Dec. 28, 2018, which is herein incorporated by reference in its entirety.

### FIELD OF THE INVENTION

The present invention relates to an apparatus and method for searching for, finding, and swapping parking locations.

### BACKGROUND

Finding available parking locations is a difficult problem that drivers may encounter on a daily basis, particularly in crowded metropolitan areas. There are a number of non-trivial challenges in the field of sharing information regarding parking availability.

### SUMMARY OF THE INVENTION

The present invention meets one or more of the above needs by providing a system and method where a driver or passenger can click a button within the mobile application apparatus and a car will be plotted on the map to indicate the current parked location of a vehicle. In some examples, latitude and longitude coordinates may be used to pinpoint location of a vehicle.

In at least one example, an apparatus is provided. The apparatus may be at least one computing device. The at least one computing device includes an accelerometer and a server configured to send and receive notifications from at least the first user and the second user. The at least one computer device is configured to receive requests for at least one available parking locations from a first user, receive notifications of the at least one available parking locations from a second user, send notifications to at least the first user and the second user, sense a geo-location of the first user and the second user, and sense a speed, an acceleration, or a speed and an acceleration of the first user and the second user.

In the apparatus, at least one computing device is configured to provide time estimations for arrival of the second user at the at least one available parking location. In the apparatus, the at least one computing device is configured to facilitate transfer of available parking to a user who reserved the at least one parking location. In the apparatus, the at least one computing device is configured to send notifications related to availability of the at least one parking location. In the apparatus, the at least one computing device is configured to send notifications related to make or model of a first vehicle of the first user or of a second vehicle of the second user. In the apparatus, the at least one computing device is configured to send notifications related to arrival timing of the second user to the at least one parking location. In the apparatus, the at least one computing device is configured to provide notifications of parking availability based on street signs in free or metered parking locations. In the apparatus, the server is configured to record acceptance of a parking location booking between the first user and the second user.

In one example a method is provided. The method includes acts of receiving input to a server from a first user regarding make or model of a vehicle, detecting a geo-location of the first user, receiving input from the first user regarding future availability of a parking location; and detecting a change in acceleration that indicates the parking location is vacant.

The method may further include the act of recording a departure time of the first user on a parking spot board. The method may further include the act of receiving input to a server from a second user regarding the make or model of a second vehicle. The method may further include the act of sending at least one notification to the first user indicating that the second user sent a booking request to move into the parking location. The method may further include the act of detecting a geo-location of the second user. The method may further include the act of sending at least one notification to a second user indicating that the booking request was either accepted or denied. The method may further include the acts of recording the booking request on the server and removing the parking location from the parking spot board when the booking request is accepted. The method may further include the act of sending at least one notification to at least one of the first user and the second user regarding parking regulations for a given parking location. The method may further include the act of detecting a speed, an acceleration, or a speed and an acceleration of at least one of the first user and the second user. The method may further include the act of sharing over the server the make or model of the first user with the second user. The method may further include the act of sharing over the server the make or model of the second user with the first user. The method may further include the act of sharing over the server an estimated time of arrival to the parking location of the second vehicle with the first vehicle.

In one example, a method is provided. The method includes the acts of providing data to a processor regarding vacancy of one or more parking locations in a given geographic region, displaying parking availability to a user via a display screen, collecting data in an application regarding a parked location of a vehicle, and collecting a payment for parking in the parked location via the application.

In one example, an apparatus is provided where the user returns to within 100 feet of their parked car location and then accelerates at a cars pace, the apparatus marks that as a vacated spot with the time of departure. The community is notified of the recently vacated spot as the parked car changes from occupied to vacant.

In one example, the apparatus shows all of the community parking information including; occupied parking spots, recently vacated parking spots, available parking spots with the future time of planned departure and the location of your own parked car.

In one example, a method is provided that enables users to inform drivers that they are vacating their parking spot by indicating the future time they plan to vacate their parking spot.

In one example, a method is provided where a user can request an occupied parking spot for a future time. The user would click a button that would transmit the request to the user currently occupying the parking spot allowing the user to accept or deny the booking request. Furthermore, once the user of the occupied parking spot accepts the booking request, the car make, model and color of the occupied parking spot and the requestor of the parking spot are sent to one another, so they can identify the car they are exchanging the parking spot with.

The method may further include the act of sharing the geo-location and estimated time of arrival of the user requesting the parking spot (for example, 15 minutes prior to the time of booking until the actual time of booking). The method may further include the act of indicating if a first user will be late for the parking spot booking which will send a notification to a second user letting them know you will be late and asking for their acceptance or cancellation of the late request. The method may further include the act of indicating if the parking spot booking exchange was successful by both the occupant of the parking spot and the requestor of the parking spot. The method may further include the act of listing all of the recently vacated parking spots, available parking spots with the future time of planned departure and the location of your own parked car. By clicking on the listed parking spot, the user will be brought to the geo-location of the parking spot on the map.

Still other aspects, examples, and advantages of these exemplary aspects and examples, are discussed in detail below. Moreover, it is to be understood that both the foregoing information and the following detailed description are merely illustrative examples of various aspects and are intended to provide an overview or framework for understanding the nature and character of the claimed subject matter. Any example disclosed herein may be combined with any other example. References to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

Furthermore, in the event of inconsistent usages of terms between this document and documents incorporated herein by reference, the term usage in the incorporated references is supplementary to that of this document; for irreconcilable inconsistencies, the term usage in this document controls. In addition, the accompanying drawings are included to provide illustration and a further understanding of the various aspects and examples and are incorporated in and constitute a part of this specification. The drawings, together with the remainder of the specification, serve to explain principles and operations of the described and claimed aspects and examples.

### DESCRIPTION OF THE DRAWINGS

FIG. 1 illustrates a screen shot with a user indication of a location of an occupied parking spot, in accordance with one embodiment of the disclosure.

FIG. 2A illustrates a screen shot showing a schematic indicating a user leaving and returning to a location of a parked vehicle, in accordance with one embodiment of the disclosure.

FIG. 2B illustrates a screen shot showing a schematic of a vehicle departing from a parked location, in accordance with one embodiment of the disclosure.

FIG. 2C illustrates a screen shot illustrating a vacated parking spot with a date and time of departure, in accordance with one embodiment of the disclosure.

FIG. 3 illustrates an example screen shot, showing a user's parked location, available spots nearby, and the future time of planned departures, in accordance with one embodiment of the disclosure.

FIG. 4 is a flow chart illustrating a method for sharing an available parking location, in accordance with one embodiment of the disclosure.

FIGS. 5A-F illustrate screen shots of the steps shown in FIG. 4, in accordance with one embodiment of the disclosure.

FIG. 6 is a flow chart illustrating a method for sharing car profile information and time of arrival of the first car and the second car, in accordance with one embodiment of the disclosure.

FIGS. 7A-B are screen shots illustrating parking regulations for a given location, in accordance with one embodiment of the disclosure.

FIG. 8 is an example screen shot illustrating data collected for a given vehicle, in accordance with one embodiment of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

In metropolitan cities, for example, drivers may spend on average about thirty minutes circling the block searching for a parking spot, wasting time, adding to the congestion of the streets and emanating carbon dioxide emissions into the atmosphere. Particularly with the increase in the number of drivers on the streets due to emerging ride hailing and autonomous vehicle services, the demand for curb and street spaces continues to rapidly increase in all major cities.

Currently, there is an unmet need for a service that enables users to share information on the occupancy and vacancy of their parking spots to create greater efficiency of resources in the street-parking system. The system and method described herein are configured to allow users to transmit a location of an available or soon-to-be-vacated parking spot to a server via a mobile device. The system and method described herein are configured to detect when a user enters a requested parking spot. The system and method described herein are configured to detect when a user accelerates at a pre-determined speed. The system and method described herein are configured to use an accelerometer to detect acceleration. The system and method described herein are configured to enable a user to search for a parking spot. The system and method described herein are configured to enable a user to host a parking spot with a specified future time of departure to facilitate the exchange of parking spots between users. The system and method described herein are configured to provide a user with the parking sign regulations tailored to the geo-location of a user and the time of day. The system and method described herein may also calculate and advise users of parking patterns and notify users when parking regulations are suspended. The system and method described herein are configured to detect and/or issue notifications related to a car's geo-location in conjunction with street parking regulations. The system and method described herein are configured to issue notifications related to a lapse in the legally permitted parking timeframe for a given parking location. The system and method described herein are configured to provide a list and/or a map of available parking locations within a vicinity of a desired parking location. The system and method described herein are configured to provide a list and/or a map of available parking locations in the vicinity of a user's geo-location. The system and method described herein are configured to indicate to a user “hot” area with more available parking locations and/or “cold” areas with fewer available parking locations. For example, “hot” areas may be indicated with a color, such as red and “cold” areas may be indicated with a color, such as blue. The system and method described herein are configured to track user parking activity data. The system and method described herein are configured to detect patterns in user parking activity data. The system and method described herein are configured to provide suggestions on parking locations that may be vacated within a specified timeframe of a desired parking time. The system and method described herein are configured to provide a suggested user match for users who exhibit opposite parking schedules (i.e. users can sync up to trade a given parking location). The system and method described herein are configured to provide a user match based on tracked patterns of user parking activity data. The system and method described herein are configured to incentivize users to host a parking location through the application software with a user who desires a given parking location.

In some embodiments, the system and method are configured to provide a list and/or a map of all of the recently vacated parking spots. In some embodiments, the system and method are configured to utilize tracked history of parking locations to predict future availability of parking in a given region or specific parking location. In some embodiments, the system and method are configured to provide a list and/or map of available parking spots with an indication of an estimated future time of planned departure.

In some embodiments, the system and method are configured to use the geo-location of your own car to prioritize the list to include the closest locations at the top and/or the most convenient estimated departure times based on entered user data. In some embodiments, clicking on the listed parking spot will provide a user with the geo-location of the parking spot on the map.

In some embodiments, the system and method are configured to provide a curb space management platform. The curb space management platform is configured to provide data on occupancy versus vacancy rates for a given region or for a specific parking location. In some embodiments, the system and method are configured to provide utilization data for a given region or a specific parking location. Utilization data may include turnover rates for street parking spots, occupancy and vacancy levels by street, neighborhood, or zipcode. In some embodiments, and for certain geographic regions, a dollar amount may be tied to a public parking location. In some embodiments, parking fees may be collected for passenger vehicles and/or commercial vehicles. The system and method may be configured to collect payment for a given parking location based on a predetermined price for that parking location at a particular time of day. In some embodiments, the system and method may be linked to a street side regulator that is configured to collect payments for metered parking locations and/or issue tickets for vehicles parking in expired or unpaid parking locations. Data collected using the system and method may be used to generate pricing based on usage, demand, and/or availability. The system and method are configured to provide access to data regarding both availability (occupancy and vacancy of parking spots in a given region) and pricing simultaneously to a user. In a high volume market, this data would provide critical time savings to a user. The ability for a user to also pay through the software application for a parking location would provide additional critical time savings to a user.

In some embodiments, the system and method are configured to track motion. In some embodiments, the system and method are configured to activate or communicate with an accelerometer to detect and distinguish between different movements or motion of a user. In some embodiments, the accelerometer may be integral with the vehicle, integral with a mobile device, or both integral with the vehicle and a mobile device. Data can be collected from the vehicle, the mobile device, or both the vehicle and the mobile device. In some embodiments, the system and method are configured to detect and distinguish between a user walking, driving or in a non-moving position (i.e. stationary or parked). In some embodiments, the system and method are configured to detect a transition between a non-moving position and an acceleration and interpret this change as leaving a parked location. In some embodiments, the system and method relate to an exchange forum for the transfer of a recently vacated parking spot from one user to a second user who is searching for a parking spot. In some embodiments, the system and method described herein can be utilized with autonomously controlled vehicles. In some embodiments, the system and method described herein may provide instructions to an autonomously controlled vehicle to direct it to a parking location which is confirmed as available.

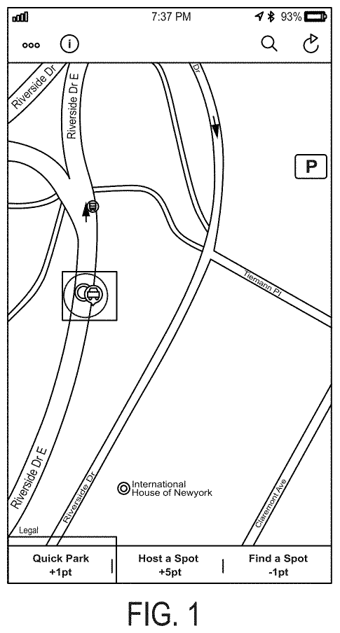

Turning now to the drawings to illustrate examples of embodiments of the present teachings, FIG. 1 details an example screen shot showing a user indication of a location of an occupied parking location. During use of the system and method described herein, an exchange is made between a user in an occupied parking location and a user in search of an available parking location.

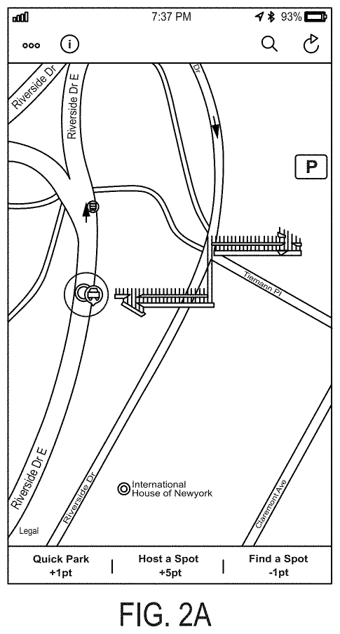

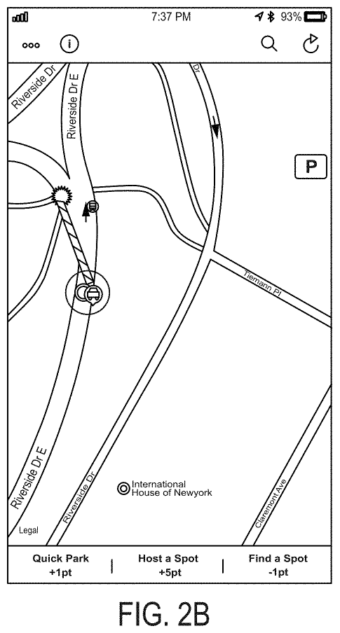

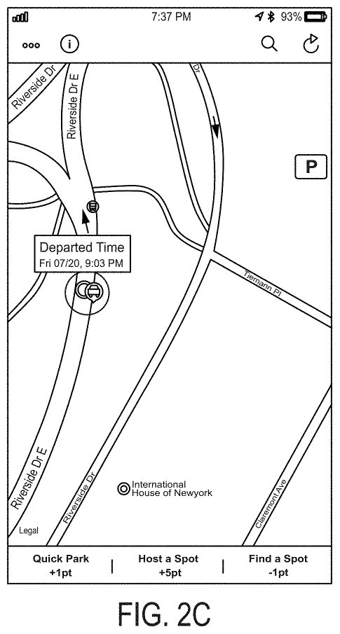

Referring to FIGS. 2A-C, a set of screen shots illustrate an exemplary system wherein the user of the occupied parking spot leaves, subsequently returns to their parking spot and accelerates at a pre-determined pace, indicating a recently vacated parking spot according to embodiments of the present invention. In some embodiments, the system and method are configured to detect when a user returns to within 100 feet of their occupied parking spot. In some embodiments, the pre-determined pace is a pace of normal car acceleration.

In FIG. 2A, a display will be presented on a user's screen when a user leaves a parked car location and returns to the parked car location. Display, as used herein, may refer to the display on a mobile device, the display on an infotainment center or display screen of a vehicle, or both the display on a mobile device and the display on an infotainment center or display screen of a vehicle. In some embodiments, the system and method described herein are presented as a software application to be utilized within a vehicle. In some embodiments, the system and method described herein are presented as a software application to be utilized on a mobile device. In FIG. 2B a user accelerates at a certain pace, which may be the pace of normal car acceleration. In FIG. 2C a parking spot is automatically marked as vacated with a date and/or time of departure.

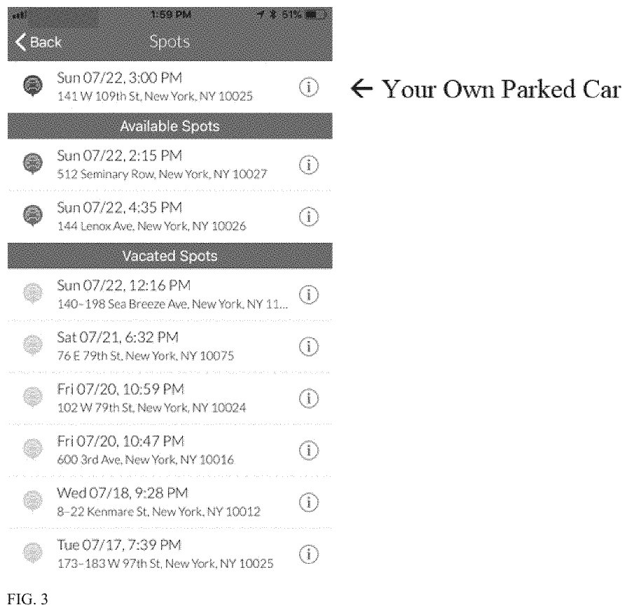

Referring to FIG. 3, a screen shot illustrates community parking information. Community parking information may include occupied parking spots, recently vacated parking spots, available parking spots with the future time of planned departure and the location of a user's parked car.

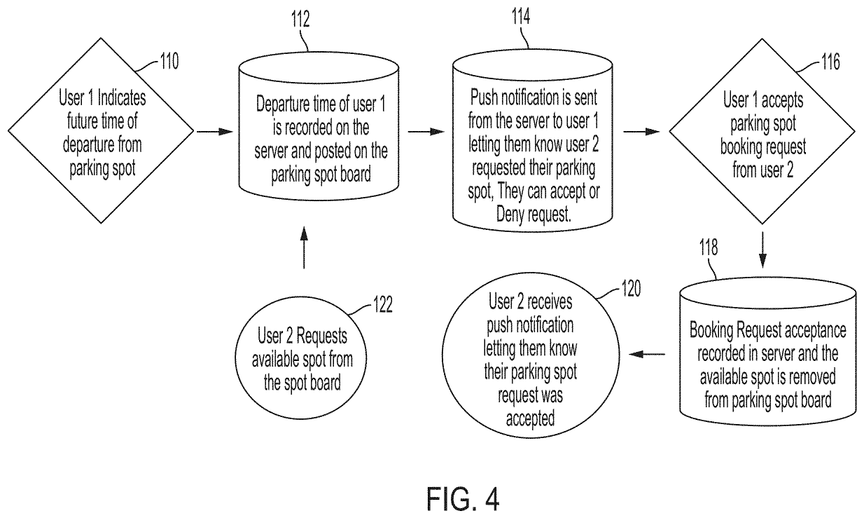

Referring to FIG. 4, unique steps in a method for sharing a parking location are detailed, in an example embodiment of a parking spot booking exchange service. Through the system and method described herein, a first user is able to post a future time they plan to depart an occupied parking spot and a second user is able to request the parking spot. In some embodiments, the first user is able to accept or deny the booking request.

In step 110, a first user indicates a future time of departure from a parking location. In step 112, a departure time of a first user is recorded on a server location and posted on the parking spot board. In step 114, a push notification is sent from the server to a first user letting them know a second user requested the parking location of the first user. The first user is given the option to either accept or deny the request. In step 116, the first user accepts the parking location booking request from the second user. In step 118, the booking request acceptance is recorded on the server and the available parking location is removed from the parking spot board. In step 120, the second user receives a push notification letting them know the parking spot request was accepted. In step 122, the second user may request an available parking location from the parking spot board.

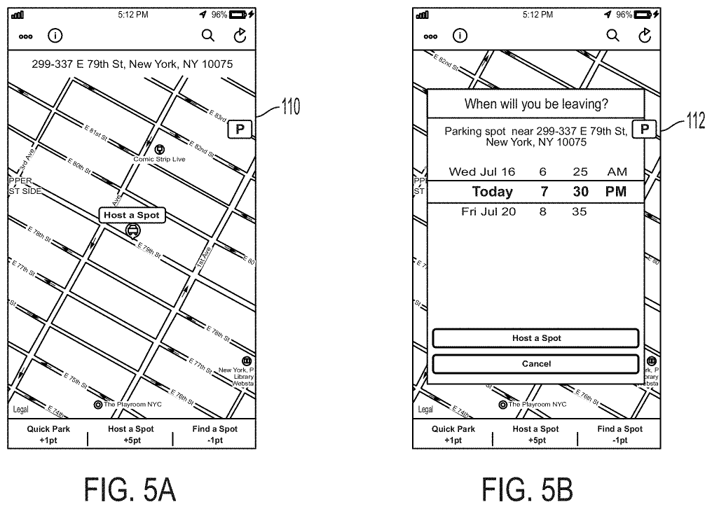

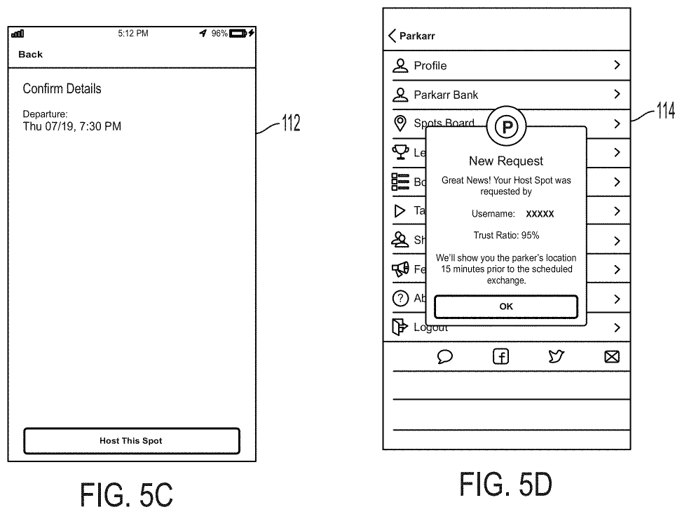

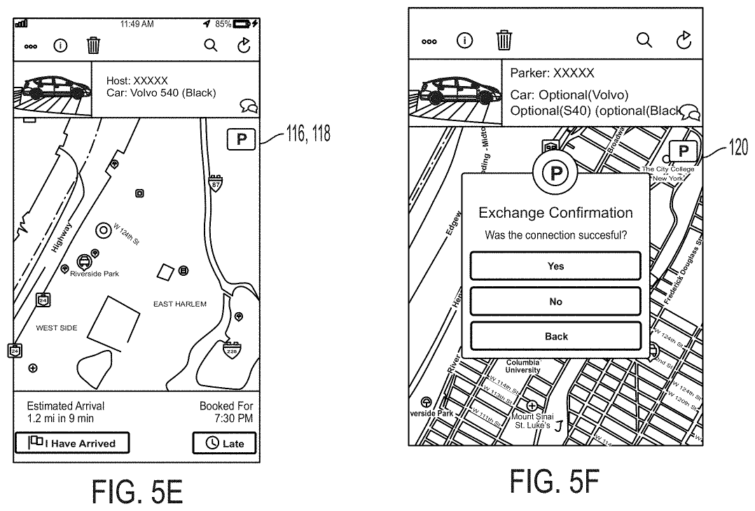

Referring to FIGS. 5A-F, screen shots illustrating a user's experience of each of steps 110, 112, 114, 116, 118, and 120 are illustrated.

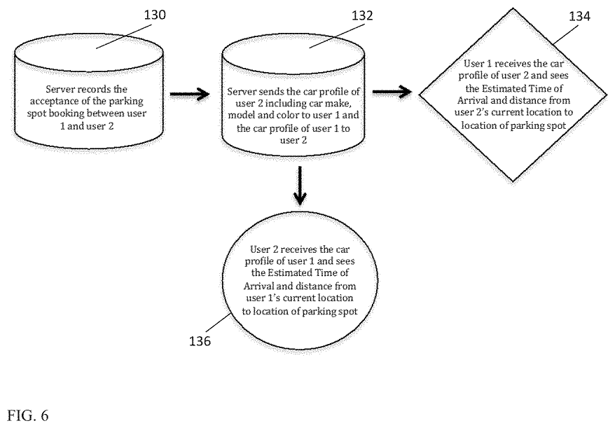

Referring to FIG. 6, steps 130, 132, 134, and 136 are detailed which describe sharing of vehicle profile information and time of arrival of a first car and a second car to the parking spot transfer point. Once a booking request is accepted, car profile information (such as vehicle make, model) of a first user and a second user is shared so that an exchange can be made with the correct vehicle. The system and method are configured to enable communication between users, to track the geo-location of the vehicles fifteen minutes prior to the booking exchange, and to provide the estimated time of arrival of each vehicle. The system and method are configured to track the geo-location of a first user and a second user. The system and method are configured to indicate if the parking spot exchange was successful or unsuccessful. The system and method are configured to provide an incentive for successful exchanges and/or a disincentive for unsuccessful exchanges. The parking spot exchange service enables communication between users in order to reserve a desired parking location and facilitate the exchange of the parking location between the intended parties.

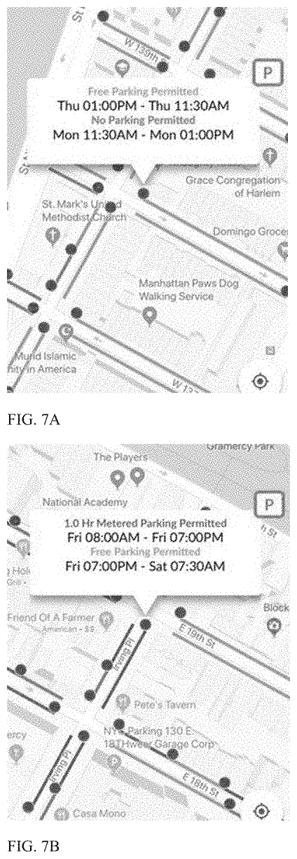

Referring to FIGS. 7A-B, indicators are provided for a user to determine if parking is free and/or valid. Vectors along a given street in a street view display may be provided with a color code to illustrate if parking is free and/or valid for a given region of specific location. Specifics of time of day may be provided to aid in determining if parking is permitted or not for a given region or specific location. For example, if the streets are shown in green, the user can park on that street at that time of day; if the streets are shown in blue, the user would be notified that this is a metered parking zone; if the streets are shown in red, the user would be notified that parking is not permitted on that street at that time of day.

The system and method are configured to provide specific sign verbiage including the current regulation and the next applicable parking regulation so that the user may be able to plan ahead when they will need to move their vehicle since the parking location may no longer be valid after a certain time according to the parking sign regulations.

In FIG. 7A, “free parking permitted” and “no parking permitted” indicators, including specific hours associated with each, are shown over a street view. In FIG. 7B, “metered parking permitted” and “free parking permitted” indicators, with specific hours associated with each, are shown over a street view. In some embodiments, specifics may be provided for a particular class of vehicle. For example, if the user has registered with a commercial vehicle, commercial vehicle parking regulations may be provided via the user interface. If the user has registered with a passenger car, passenger car parking regulations may be provided via the user interface. For parking locations that are considered mixed use spaces where some hours are designated as commercial and some hours are designated as parking for passenger vehicles, the system and method are configured to parse through this data and provide it in a systematic way to a target demographic or user population.

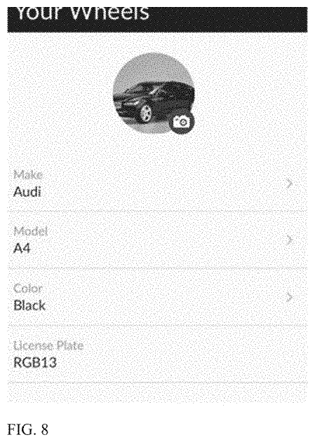

FIG. 8 details for a given user the types of data that may be collected by the platform. Vehicle make, vehicle model, vehicle color, license plate number may be collected for each user and/or may be required information to participate in the platform. Knowledge of a given user's type of vehicle will help facilitate transfer or a given parking location from one vehicle to the next. In some embodiments, the software may be configured to scan a user's driver's license and match vehicle information with a driver's license.

### Accelerometer

Functionally, detection of a user's acceleration is used to determine whether a car is parked, leaving a parking spot, and/or traveling from one point to another. The program may be designed to indicate that a user is leaving a parking spot when a user accelerates at a pre-determined speed. An accelerometer may be used to detect acceleration. A change in acceleration from a resting state to a moving state can be configured to indicate to the processor that a vehicle has exited a parking location. A change in acceleration from a moving state to a resting state, and remains in a resting state for a pre-determined period of time can be configured to indicate to the processor that the vehicle has parked. During an acceleration of a user at a pre-determined rate, the server may mark that parking spot as a vacated parking spot and indicate a time of departure. The pre-determined rate may be greater than 5 miles per hour, greater than 10 miles per hour, greater than 15 miles per hour, or greater than 20 miles per hour.

Some embodiments of the disclosure include utilizing the accelerometer that is built into a hand-held computer, a smart phone device, or other mobile device. Some embodiments of the disclosure include utilizing the accelerometer that is built directly into a vehicle. Some embodiments of the disclosure include sending accelerometer information over Bluetooth, a wired, or a wireless connection to transfer acceleration information.

What is claimed is:

1. An apparatus, comprising:
at least one computing device, the at least one computing device comprising an accelerometer, the at least one computing device configured to
receive requests for at least one available parking locations from a first user;
receive notifications of the at least one available parking locations from a second user;
send notifications to at least the first user and the second user;
sense a geo-location of the first user and the second user; and
sense a speed, an acceleration, or a speed and an acceleration of the first user and the second user; and
a server configured to send and receive notifications from at least the first user and the second user.

2. The apparatus of claim 1, wherein the at least one computing device is configured to provide time estimations for arrival of the second user at the at least one available parking location.

3. The apparatus of claim 1, wherein the at least one computing device is configured to facilitate transfer of available parking to a user who reserved the at least one parking location.

4. The apparatus of claim 3, wherein the at least one computing device is configured to send notifications related to availability of the at least one parking location.

5. The apparatus of claim 3, wherein the at least one computing device is configured to send notifications related to make or model of a first vehicle of the first user or of a second vehicle of the second user.

6. The apparatus of claim 3, wherein the at least one computing device is configured to send notifications related to arrival timing of the second user to the at least one parking location.

7. The apparatus of claim 1, wherein the at least one computing device is configured to provide notifications of parking availability based on street signs in free or metered parking locations.

8. The apparatus of claim 1, wherein the server is configured to record acceptance of a parking location booking between the first user and the second user.

9. A method, comprising:
receiving input to a server from a first user regarding make or model of a vehicle;
detecting a geo-location of the first user;
receiving input from the first user regarding future availability of a parking location; and
detecting a change in acceleration that indicates the parking location is vacant.

10. The method of claim 9, further comprising:
recording a departure time of the first user on a parking spot board.

11. The method of claim 10, further comprising:
receiving input to a server from a second user regarding the make or model of a second vehicle.

12. The method of claim 11, further comprising:
sending at least one notification to the first user indicating that the second user sent a booking request to move into the parking location.

13. The method of claim 12, further comprising:
detecting a geo-location of the second user.

14. The method of claim 13, further comprising:
sending at least one notification to a second user indicating that the booking request was either accepted or denied.

15. The method of claim 14, further comprising:
recording the booking request on the server and removing the parking location from the parking spot board when the booking request is accepted.

16. The method of claim 9, further comprising:
sending at least one notification to at least one of the first user and the second user regarding parking regulations for a given parking location.

17. The method of claim 11, further comprising:
detecting a speed, an acceleration, or a speed and an acceleration of at least one of the first user and the second user.

18. The method of claim 13, further comprising:
sharing over the server the make or model of the first user with the second user; and
sharing over the server the make or model of the second user with the first user.

19. The method of claim 18, further comprising:
sharing over the server an estimated time of arrival to the parking location of the second vehicle with the first vehicle.

20. A method comprising:
providing data to a processor regarding vacancy of one or more parking locations in a given geographic region;
displaying parking availability to a user via a display screen;
collecting data in an application regarding a parked location of a vehicle; and
collecting a payment for parking in the parked location via the application.
